(19) United States
(12) Patent Application Publication
(10) Pub. No.: US 2026/0098425 A1
(43) Pub. Date: Apr. 9, 2026

(54) ELECTROMECHANICAL LOCK

(71) Applicant: iLOQ Oy, Oulu (FI)

(72) Inventors: Tommi Sintonen, Oulu (FI); Matti Ylitalo, Oulu (FI); Juha Kyrönlampi, Oulu (FI)

(21) Appl. No.: 19/405,583

(22) Filed: Dec. 2, 2025

Related U.S. Application Data
(63) Continuation-in-part of application No. 17/733,372, filed on Apr. 29, 2022, now Pat. No. 12,509,916.

(51) Int. Cl. E05B 47/00

(52) U.S. Cl. CPC E05B 47/0001; E05B 2047/0037

(57) ABSTRACT

An electromechanical lock includes a lock cylinder having core front and back ends, and an operation knob, coupled with the core front end, enabling a user to rotate the operation knob from an initial knob position so the core front end rotates with the core back end from a locked rear position to a unlocked rear position in an unlocked state of the electromechanical lock. The electromechanical lock further includes a return force mechanism rotating the operation knob towards the initial position after the user first has rotated the operation knob away from the initial knob position and then released the operation knob. The return force mechanism includes first and second magnetic parts coupled with the operation knob and a lock cylinder core body, respectively. An interaction between first and second magnetic force fields of the first and second magnetic parts, respectively, is configured to rotate the operation knob.

### CROSS REFERENCE TO RELATED APPLICATIONS

This application is a continuation-in-part of U.S. application Ser. No. 17/733,372 filed Apr. 29, 2022, the entire contents of which are hereby incorporated by reference.

### FIELD

Various embodiments relate to electromechanical locks.

### BACKGROUND

Electromechanical locks are emerging to replace traditional mechanical locks. One branch of electromechanical locks are keyless electromechanical locks, wherein instead of having a key, a fixed operation knob may be used. The operation knob may include an antenna to receive the electric energy. The electric energy may be harvested from an NFC (Near-Field Communication) signal transmitted by a user apparatus, for example.

A specific problem relates to the keyless electromechanical locks. In traditional mechanical locks, as the correct key is pushed into the lock cylinder, internal tumblers (pins, discs, levers, or wafers, for example) release internal parts of the lock cylinder coupled with a tailpiece to rotate in unison with the key. As the key can only be removed in one position, it is easy to ensure, that the internal parts (and the tailpiece) are returned to a locked position before the key can be retracted.

However, the keyless electromechanical lock operates without the key, and thereby the reset of the lock is a problem.

### BRIEF DESCRIPTION

According to an aspect, there is provided subject matter of independent claims. Dependent claims define some embodiments.

One or more examples of implementations are set forth in more detail in the accompanying drawings and the description of embodiments.

### LIST OF DRAWINGS

Some embodiments will now be described with reference to the accompanying drawings, in which

FIG. 1A, FIG. 1B, FIG. 1C, FIG. 1D, FIG. 1E, FIG. 1F, and FIG. 1G illustrate embodiments of an electromechanical lock cylinder;

FIG. 2A and FIG. 2B illustrate embodiments of an operation knob;

FIG. 3A and FIG. 3B illustrate embodiments of adaptors for the electromechanical lock cylinder;

FIG. 4A, FIG. 4B, and FIG. 4C illustrate embodiments of a return force mechanism of the electromechanical lock cylinder;

FIG. 5A and FIG. 5B illustrate additional embodiments of the return force mechanism; and

FIG. 6A and FIG. 6B, FIG. 7A and FIG. 7B, FIG. 8A and FIG. 8B, and FIG. 9A and FIG. 9B, illustrate pairwise additional embodiments of the return force mechanism and magnetic field forces involved.

### DESCRIPTION OF EMBODIMENTS

The following embodiments are only examples. Although the specification may refer to “an” embodiment in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

Reference numbers, both in the description of the embodiments and in the claims, serve to illustrate the embodiments with reference to the drawings, without limiting it to these examples only.

The embodiments and features, if any, disclosed in the following description that do not fall under the scope of the independent claims are to be interpreted as examples useful for understanding various embodiments of the invention.

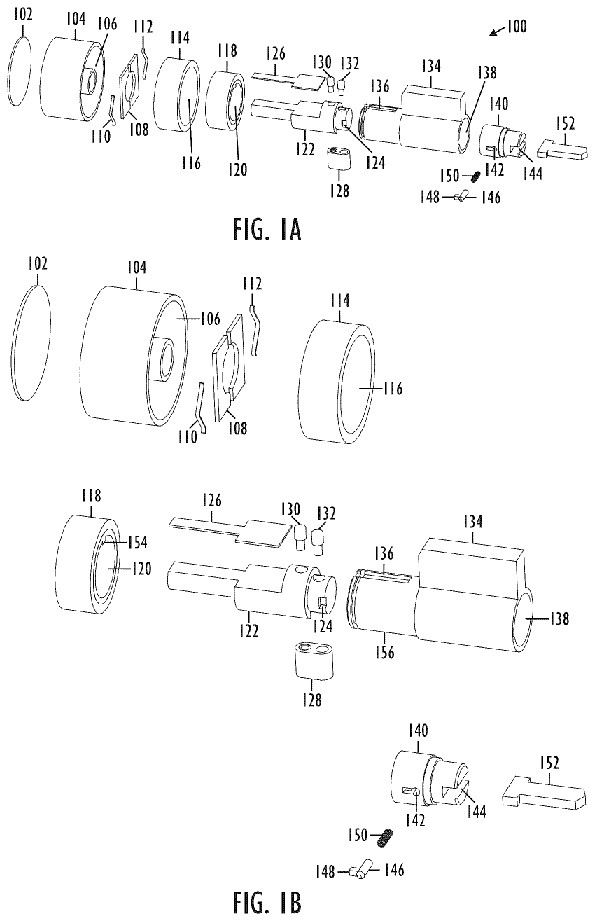

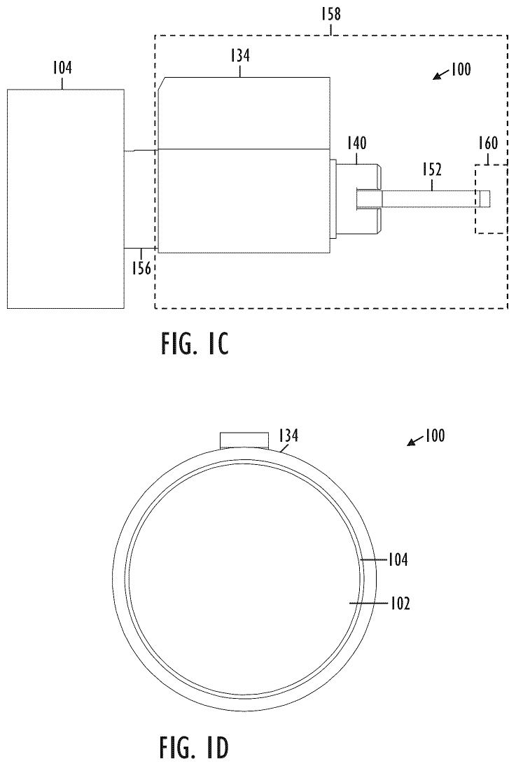

Let us now study an electromechanical lock cylinder 100 with reference to the drawings, wherein various views are illustrated:
FIG. 1A illustrating an exploded view;
FIG. 1B illustrating an enlarged exploded view;
FIG. 1C illustrating an external side view;
FIG. 1D illustrating an external end view towards an operation knob 104;
FIG. 1E illustrating an exploded side view;
FIG. 1F illustrating an exploded top view; and
FIG. 1G illustrating an external end view towards a core back end 140 and a tailpiece 152.

In an embodiment, the electromechanical lock cylinder 100 operates without a key, i.e., as a keyless electromechanical lock cylinder 100.

In an embodiment, the electromechanical lock comprises a lock cylinder 100 having a core front end 122 and a core back end 140, an operation knob 104 and a return force mechanism 114, 118.

The core back end 140 is coupled with a tailpiece 152. As shown in FIG. 1B, the core back end 140 may include a cut out 144 to receive a matching end of the tailpiece 152.

The tailpiece 152 is coupleable to a bolt mechanism 160.

In an embodiment, the electromechanical lock comprises an actuator mechanism 126, 128, 132 switchable between a locked state and an unlocked state.

The actuator mechanism 126, 128, 132 is configured:
to keep the core front end 122 uncoupled with the core back end 140 in the locked state;
to couple the core front end 122 with the core back 140 end in the unlocked state to enable the core front end 122 to rotate the core back end 140 from a locked rear position to an unlocked rear position; and
to return to keep the core front end 122 uncoupled with the core back end 140 in the locked state.

The operation knob 104 is coupled with the core front end 122. The operation knob 104 is configured to enable a user to rotate the operation knob 104 from an initial knob position so that the core front end 122 rotates the core back end 140 from the locked rear position to the unlocked rear position in the unlocked state.

In an embodiment, the actuator mechanism 126, 128, 132 switches from the locked state to the unlocked state by coupling the core front end 122 to the core back end 140 by inserting a coupling pin 132 into a notch 164.

In an additional embodiment, the actuator mechanism 126, 128, 132 switches from the locked state to the unlocked state by additionally releasing the core front end 122 to rotate by withdrawing a locking pin 130 from a notch 162 in a core body 134 of the electromechanical lock cylinder 100.

In an embodiment, the actuator mechanism 126, 128, 132 switches from the locked state to the unlocked state by changing an internal magnetic field configuration to operate the coupling pin 132 and the locking pin 130.

In an embodiment, the locking pin 130 and the coupling pin 132 may be housed in a same case 128. The pins 130, 132 may be implemented as moving permanent hard magnets, and the case 128 may comprise stationary permanent semi-hard magnets, whose magnetization configurations may be changed by electrically powered magnetization coils housed in the case 128. With this kind of operation, both pins 130, 132 may move simultaneously.

The core front end 122 and the core back end 140 may be housed in a hollow 138 of a core body 134.

In an embodiment, the electromechanical lock cylinder 100 is configured so that the core body 134 defines its external surface according to a technology standard related to locks. In this way, a standard mechanical lock cylinder may be replaced with the electromechanical lock cylinder 100. ANSI (American National Standards Institute), for example, defines such technology standards. However, the electromechanical lock cylinder 100 may be designed and dimensioned so that instead of a lock standard, the electromechanical lock cylinder 100 may be fitted into a space defined by a proprietary lock specification. In an embodiment, the electromechanical lock cylinder 100 is a key-in-knob (KIK) type cylinder, a key-in-lever (KIL) type cylinder, a mortise cylinder, a rim cylinder, a small format interchangeable core (SFIC) cylinder, or a large format interchangeable core (LFIC) cylinder.

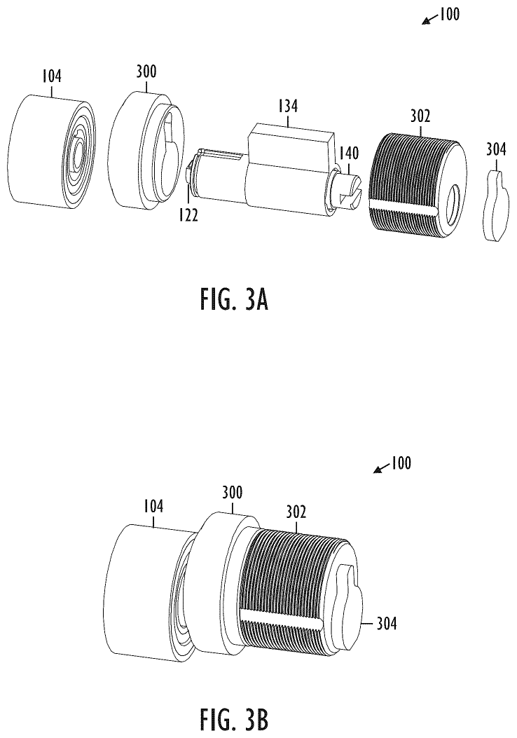

In an embodiment illustrated in FIG. 3A and FIG. 3B, modular parts 300, 302, 306 adapt the electromechanical lock cylinder 100, which is designed as a KIK cylinder so that it may be fitted into an installation requiring a mortise cylinder. With the same principle, other kinds of modular parts may be designed to enable an installation of a general electromechanical lock cylinder 100 in place of various standard or proprietary cylinders.

The above described core mechanism and its operation is described in more detail in other patents and applications by the applicant, such as US 10,443,269 B2 and US 2021/0207399 A1, incorporated herein as references in all jurisdictions where applicable.

In an embodiment, the electromechanical lock cylinder 100 further comprises an antenna 102 in the operation knob 104 to receive wirelessly encrypted data from a portable user apparatus, and a processor 126 to switch the actuator mechanism 126, 128, 132 from the locked state to the unlocked state provided that the received encrypted data matches a predetermined condition. Note that in FIG. 1B, the processor 126 is represented by a printed circuit board, which is then provided with the needed electronics.

In an embodiment, the antenna 102 is further configured to harvest wirelessly electric energy from the portable user apparatus for the operation of the electromechanical lock cylinder 100.

US 11,164,407 B2, another patent of the applicant, incorporated herein as a reference in all jurisdictions where applicable, illustrates operation of the Near-Field Communication (NFC) protocol enabling the wireless communication and energy harvesting of the electromechanical lock cylinder 100.

In an embodiment, the electromechanical lock cylinder 100 further comprises an enforced coupling 124, 142, 146, 148, 150. With the enforced coupling and/or the return force mechanism, the reset of the internals parts of the electromechanical lock cylinder 100 is achieved.

As shown in FIG. 1B, the operation knob 104 may comprise a hollow 106 to house the return force mechanism 114, 118, and fastening parts 108, 110, 112.

The enforced coupling 124, 142, 146, 148, 150 is configured to couple the core front end 122 with the core back end 140 as the core front end 122 starts to rotate the core back end 140 away from the locked rear position in the unlocked state and decouple the core front end 122 from the core back end 140 as the core back end 140 returns to the locked rear position.

As shown in FIG. 1F, the enforced coupling may be implemented as a pin 146 movable in a slot 142 of the core back end 140. The pin 146 retracts in the slot 142 against a spring 150 from a notch 166 as the cylinder is rotated, and a protrusion 148 of the pin 146 enters a notch 124 in the core front end 122, thereby coupling the core front end 122 with the core back end 140. As the core back end 140 is rotated to the locked rear position by the core front end 122, the spring 150 pushes the pin 146 back into the 166 notch, thereby releasing the enforced coupling.

The return force mechanism 114, 118 is configured to rotate the operation knob 104 further, towards the initial position, after the user first has rotated the operation knob 104 away from the initial knob position and then released the operation knob 104, whereby the core back end 140 is rotated to the locked rear position by the core front end 122 due to the coupled enforced coupling 124, 142, 146, 148, 150. The return force mechanism may return the operation knob substantially back to its initial position. It may also enable the operation knob, while returning to the initial position, to rotate either clockwise or counterclockwise (i.e. in both directions).

In an embodiment, the return force mechanism comprises a first magnetic part 114 coupled with the operation knob 104, and a second magnetic part 118 coupled with a core body 134 of the electromechanical lock cylinder 100, wherein an interaction between a first magnetic force field of the first magnetic part 114 and a second magnetic force field of the second magnetic part 118 rotates the operation knob 104 further, whereby the core back end 140 is rotated to the locked rear position by the core front end 122 due to the coupled enforced coupling 124, 142, 146, 148, 150. As shown in FIG. 1B, the second magnetic part 118 may comprise a protrusion 154 to enter a counterpart groove 136 in the core body 134. The protrusion 154 may be formed into a separate ring fixed against the inner wall of the second magnetic part 118.

In an embodiment, the first magnetic part is configured as an outer magnetic ring 114 coupled with the operation knob 104, and the second magnetic part is configured as an inner magnetic ring 118 coupled with the core body 134 of the electromechanical lock cylinder 100.

In an embodiment, the inner magnetic ring 118 is positioned in a bore 116 of the outer magnetic ring 114.

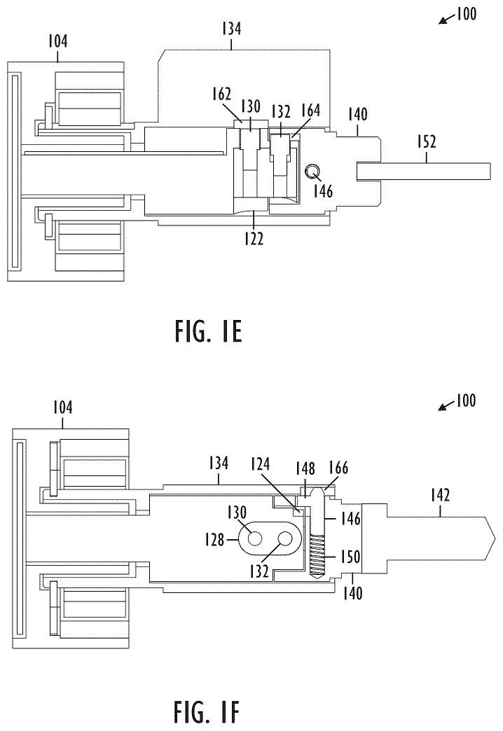

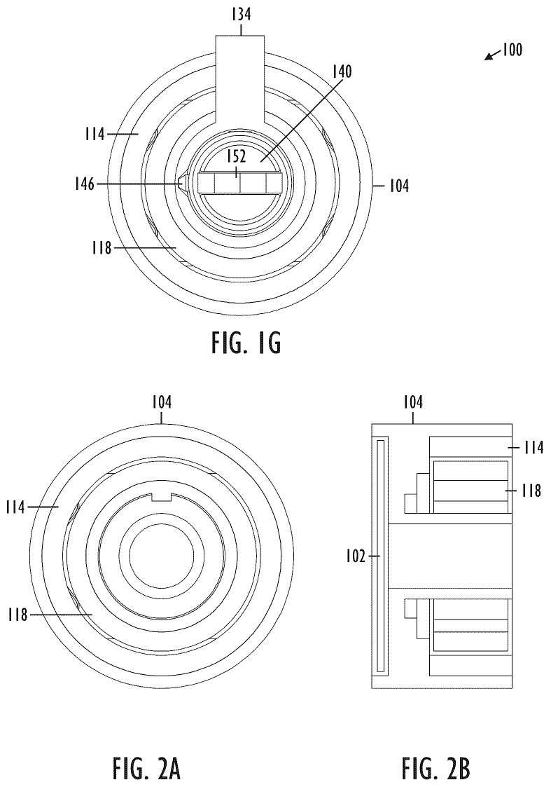

FIG. 2A illustrates an exploded view of the operation knob 104 viewed towards an end of the operation knob 104 so that the inner magnetic 118 and the outer magnetic ring 114 are visible. FIG. 2B illustrates an exploded view of the operation knob 104 viewed from the side.

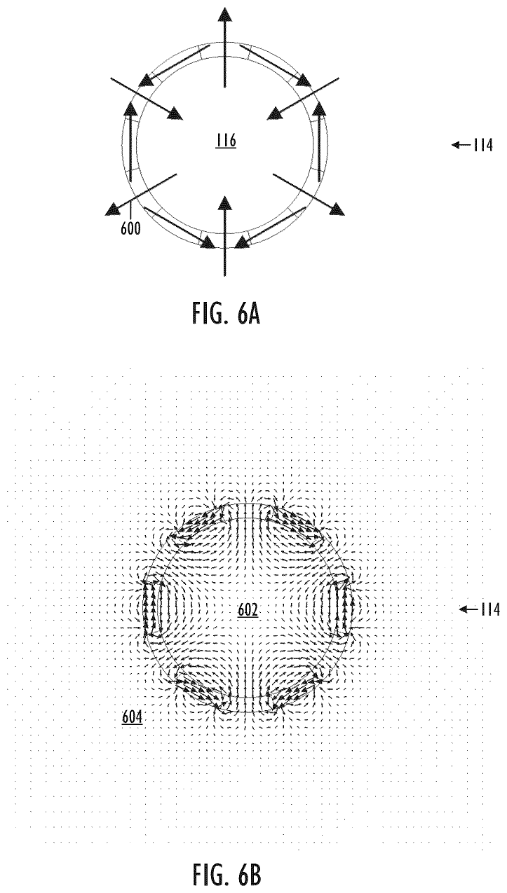

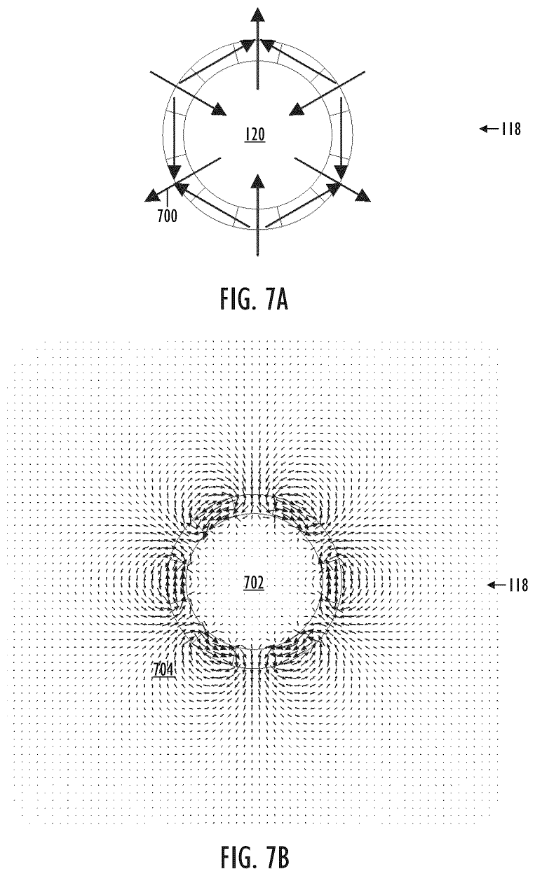

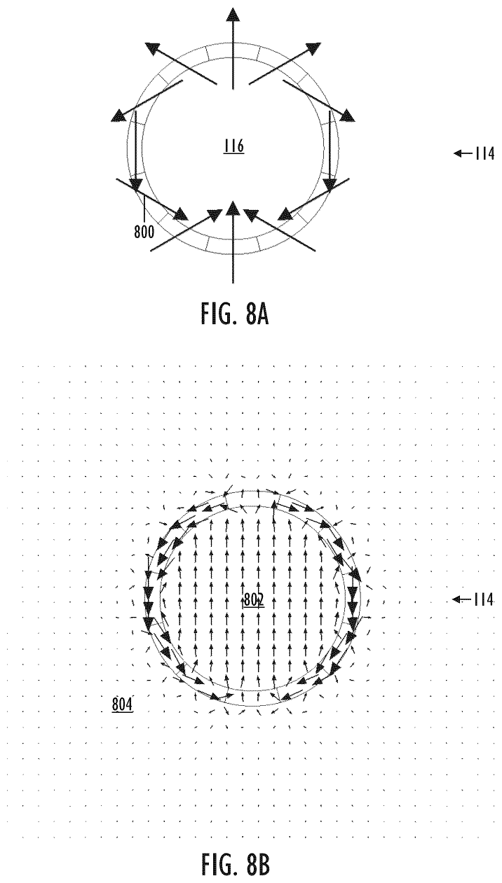

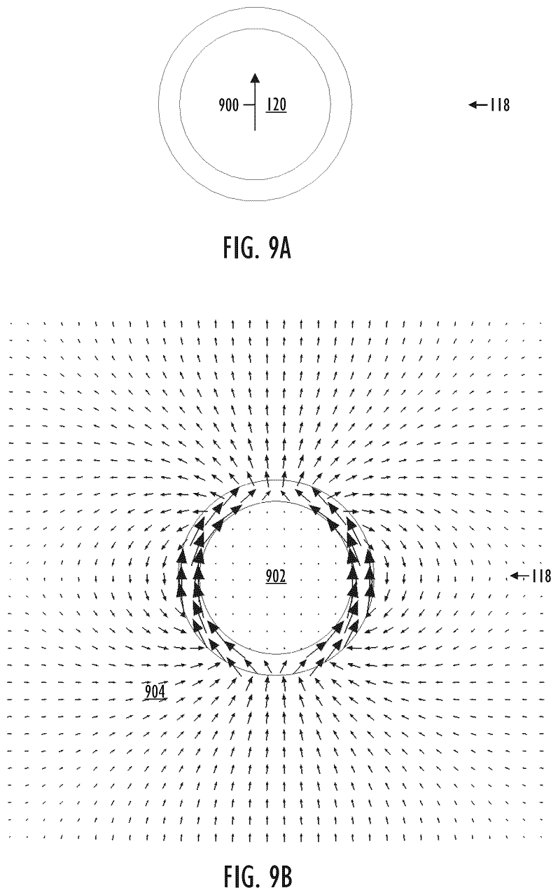

In an embodiment illustrated in FIG. 6A, FIG. 6B, FIG. 7A and FIG. 7B, the outer magnetic ring 114 is arranged as a Halbach cylinder so that a magnetic field is augmented 602 towards a bore 116 of the outer magnetic ring 114 and cancelled 604 towards the operation knob 104, and the inner magnetic ring 118 is arranged as a Halbach cylinder so that a magnetic field is augmented 704 towards the outer magnetic ring 114 and cancelled 702 towards a bore 120 of the inner magnetic ring 118. Arrows 600, 700 illustrate various magnetization patterns creating the magnetic fields 602, 604, 702, 704. In the embodiment illustrated in FIG. 6A and FIG. 6B, the Halbach cylinder has the Halbach cylinder configuration k=4. In the embodiment illustrated in FIG. 7A and FIG. 7B, the Halbach cylinder has the Halbach cylinder configuration k=−4.

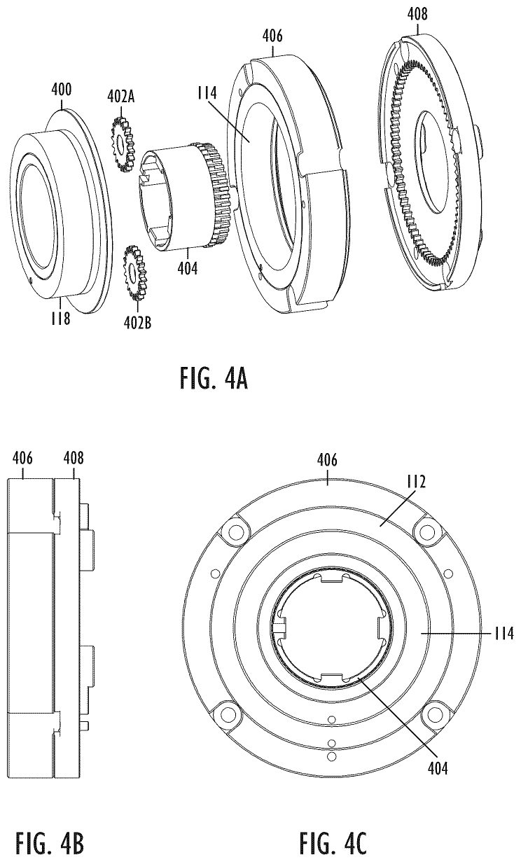

In an embodiment illustrated in FIG. 4A, FIG. 4B and FIG. 4C, the return force mechanism comprises a planetary gear 400, 402A, 402B, 404, 408 to transmit the rotation of the operation knob 104 to the core front end 122 with a gear ratio of 1:n, wherein n is greater than 1 and n is equal to a number of magnetic equilibrium positions for the inner magnetic ring 118 along the outer magnetic ring 114. In the illustrated embodiment, n=3, whereby three magnetic equilibrium positions are realized. The magnetic force field between the first magnetic part 114 and the second magnetic part 118 rotates the operation knob 104 further to one of the magnetic equilibrium positions, whereby the core back end 140 is rotated to the locked rear position by the core front end 122 due to the coupled enforced coupling 124, 142, 146, 148, 150. The planetary gear may be implemented as shown: the inner magnetic ring 118 is fixed to a planetary carrier 400, planetary cogwheels (at least one, in this example three of which two are shown) 402A, 402B, a central sun gear 404 being fixed to the core body 134, the outer magnetic ring 114 is fixed to an external ring 406, and an outer ring 408 with a toothing and fixed to the external ring 406.

In an embodiment illustrated in FIG. 8A, FIG. 8B, FIG. 9A and FIG. 9B, the first magnetic part comprises an outer magnetic ring 114 coupled with the operation knob 104 to create an uniform magnetic force field 802 inside of a bore 116 of the outer magnetic ring 114, and the second magnetic part comprises an inner dipole magnet 118 in the bore 116 of the outer magnetic ring 114 and coupled with the electromechanical lock cylinder 100, wherein an interaction between the uniform magnetic force field of the outer magnetic ring 114 and a magnetic force field 906 of the inner dipole magnet 118 rotates the operation knob 104 further to the one and only magnetic equilibrium position for the inner dipole magnet 118 along the outer magnetic ring 114, whereby the core back end 140 is rotated to the locked rear position by the core front end 122 due to the coupled enforced coupling 124, 142, 146, 148, 150. As there is only one equilibrium position, this embodiment operates without any gearing (such as the planet gearing of FIG. 4A, FIG. 4B and FIG. 4C). Arrows 800 illustrate various magnetization patterns creating the magnetic fields 802, 804. In the embodiment illustrated in FIG. 8A and FIG. 8B, the Halbach cylinder has the Halbach cylinder configuration k=2. In the embodiment illustrated in FIG. 9A and FIG. 9B, arrow 900 illustrates a magnetization pattern of the inner dipole magnet 118. The inner dipole magnet 118 may be, as shown in FIG. 9A and FIG. 9B, a dipole ring magnet magnetized along a radius.

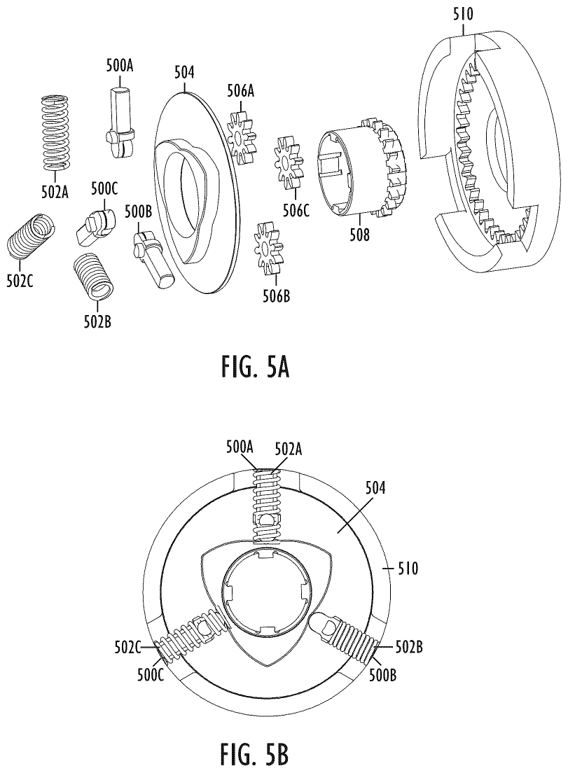

FIG. 5A and FIG. 5B illustrate an alternative embodiment of the return force mechanism operating without magnetic field forces. The embodiment has three equilibrium positions. The return force mechanism comprises three pushers 500A, 500B, 500C with springs 502A, 502B, 502C, a planetary carrier 504 with three cams, planetary cogwheels 506A, 506B, 506C, a central sun gear 508 being fixed to the core body 134, and an external ring 510 with toothing.

In an embodiment illustrated in FIG. 1C, the electromechanical lock cylinder 100 is dimensioned to be accommodated by a housing 158. In a first alternative embodiment also illustrated in FIG. 1C, the electromechanical lock cylinder 100 further comprises a cylinder extension zone 156 of a core body 134 of the electromechanical lock cylinder 100 dimensioned to protrude beyond the housing 158, wherein the operation knob 104 is supported by the cylinder extension zone 156.

In an embodiment, the extension zone is configured to receive the inner magnetic ring. The inner magnetic ring may comprise a bore and the extension zone is configured to enter the bore such that it is inside the bore in the assembled state.

In an embodiment, the extension zone comprises a first locking member and the inner magnetic ring comprises a second locking member, wherein the first and second locking members are configured to interact in the assembled state such that rotation of the inner magnetic ring in relation to the core body is prevented (limited). The second locking member may be arranged in the bore of the inner magnetic ring (inner surface), and the first locking member on an outer surface of the extension zone.

In an embodiment, the first locking member is the groove 136 and the second locking member is the protrusion 154 configured to enter the groove 136 in the assembled state to prevent rotation of the inner magnetic ring in relation to the core body. The protrusion may be arranged within the bore, as illustrated in FIG. 1B, and when the extension zone is in the bore, the protrusion is in the groove arranged on an outer surface of the extension zone preventing the rotation of the inner magnetic ring in relation to the core body.

In a second alternative embodiment (not illustrated), the electromechanical lock cylinder 100 further comprises an external extension zone of a body of the operation knob 104 dimensioned to protrude between the housing 158 and a tapered zone of a core body 134 of the electromechanical lock cylinder 100, wherein the external extension zone is supported by the tapered zone. In a third alternative embodiment (not illustrated), the electromechanical lock cylinder 100 further comprises an internal extension zone of a body of the operation knob 104 dimensioned to protrude between the core front end 122 and a core body 134 of the electromechanical lock cylinder 100, wherein the internal extension zone is supported by the core body 134 of the electromechanical lock cylinder 100.

Even though the invention has been described with reference to one or more embodiments according to the accompanying drawings, it is clear that the invention is not restricted thereto but can be modified in several ways within the scope of the appended claims. All words and expressions should be interpreted broadly, and they are intended to illustrate, not to restrict, the embodiments. It will be obvious to a person skilled in the art that, as technology advances, the inventive concept can be implemented in various ways.

1. An electromechanical lock comprising:
a lock cylinder having a core front end and a core back end;
an operation knob, coupled with the core front end, to enable a user to rotate the operation knob from an initial knob position so that the core front end rotates with the core back end from a locked rear position to an unlocked rear position in an unlocked state of the electromechanical lock; and
a return force mechanism to rotate the operation knob towards the initial position after the user first has rotated the operation knob away from the initial knob position and then released the operation knob,
wherein the return force mechanism comprises a first magnetic part coupled with the operation knob, and a second magnetic part coupled with a core body of the lock cylinder, wherein an interaction between a first magnetic force field of the first magnetic part and a second magnetic force field of the second magnetic part is configured to rotate the operation knob.

2. The electromechanical lock cylinder of claim 2, wherein the first magnetic part is configured as an outer magnetic ring coupled with the operation knob, and the second magnetic part is configured as an inner magnetic ring coupled with the core body of the electromechanical lock cylinder.

3. The electromechanical lock cylinder of claim 3, wherein the inner magnetic ring is positioned in a bore of the outer magnetic ring.

4. The electromechanical lock cylinder of claim 3, wherein the outer magnetic ring is arranged as a Halbach cylinder so that a magnetic field is augmented towards a bore of the outer magnetic ring and cancelled towards the operation knob, and the inner magnetic ring is arranged as a Halbach cylinder so that a magnetic field is augmented towards the outer magnetic ring and cancelled towards a bore of the inner magnetic ring.

5. The electromechanical lock cylinder of claim 2, wherein the first magnetic part comprises an outer magnetic ring coupled with the operation knob to create an uniform magnetic force field inside of a bore of the outer magnetic ring, and the second magnetic part comprises an inner dipole magnet in the bore of the outer magnetic ring and coupled with the electromechanical lock cylinder, wherein an interaction between the uniform magnetic force field of the outer magnetic ring and a magnetic force field of the inner dipole magnet rotates the operation knob further to the one and only magnetic equilibrium position for the inner dipole magnet along the outer magnetic ring.

6. The electromechanical lock of claim 1, wherein the lock cylinder is dimensioned to be accommodated by a housing, and the lock cylinder further comprising a cylinder extension zone of the core body of the electromechanical lock cylinder dimensioned to protrude beyond the housing, wherein the operation knob is supported by the cylinder extension zone.

7. The electromechanical lock of claim 6, wherein the extension zone is configured to receive the inner magnetic ring.

8. The electromechanical lock of claim 7, wherein the extension zone comprises a first locking member and the inner magnetic ring comprises a second locking member, wherein the first and second locking members are configured to interact to prevent rotation of the inner magnetic ring in relation to the core body.

9. The electromechanical lock of claim 8, wherein the first locking member in the extension zone comprises a groove and the second locking member in the inner magnetic ring comprises a protrusion configured to enter the groove to prevent rotation of the inner magnetic ring in relation to the core body.

10. The electromechanical lock of claim 1, wherein the electromechanical lock comprises a tailpiece coupled with the core backend and couplable to a bolt mechanism.

11. The electromechanical lock of claim 1, wherein the electromechanical lock cylinder is one of a key-in-knob type cylinder, a key-in-lever type cylinder, a mortise cylinder, a rim cylinder, a small format interchangeable core cylinder, a large format interchangeable core cylinder.

12. The electromechanical lock of claim 1, wherein the electromechanical further comprises an actuator mechanism configured to switch the lock between a locked state and the unlocked state, and configured to keep the core front end uncoupled with the core back end in the locked state, and to couple the core front end with the core back end in the unlocked state to enable the core front end to rotate the core back end from the locked rear position to the unlocked rear position.

13. The electromechanical lock cylinder of claim 1, further comprising:
an antenna in the operation knob to receive wirelessly encrypted data from a portable user apparatus; and
a processor to switch the actuator mechanism from the locked state to the unlocked state provided that the received encrypted data matches a predetermined condition.

14. The electromechanical lock cylinder of claim 13, wherein the antenna is configured to harvest wirelessly electric energy from the portable user apparatus for the operation of the electromechanical lock.
